(19) United States
(12) Patent Application Publication
(10) Pub. No.: US 2007/0266522 A1
(43) Pub. Date: Nov. 22, 2007

(54) FRICTIONAL DOOR HOLDER AND STOP

(76) Inventor: Wayne W. Li, Troy, MI (US)

Correspondence Address: WAYNE LI, 72 WEBB DRIVE, TROY, MI, 48098, US

(21) Appl. No.: 11/383,739

(22) Filed: May 16, 2006

(51) Int. Cl. E05F 5/02

(52) U.S. Cl. 16/82

(57) ABSTRACT

A frictional door holder and stop is designed to provide users with a device that retains a door in an opened position. It is simply comprised of a door holder, a door stop, and a buffer. The door holder, a bent sheet metal structure, has a door holder top near the middle to contact the door's bottom surface, a door holder front end bent upward to reduce the friction force between the door holder and the floor and prevent the floor from being scratched, and a door holder rear end set underneath the door stop to be held to a fixed position relative to the door stop and floor by connectors. The present invention is used for doors with a little retuning force making the door close such as the doors without a door closer. With the frictional door holder and stop, the door can be easily closed as usual without any extra actions such as releasing a holder by a hand or a foot. Its simple structure and characteristic of combining the door holder with the door stop will benefit the users and manufacturers.

### BACKGROUND OF THE INVENTION

Background of this invention is described as follows.

1. Field of the Invention

The present invention relates generally to a device for holding doors from moving further and back while the doors are open. It mainly is for the doors with little returning forces (for example, a door without door closer).

2. Background of the Prior Art

Different kinds of door holders were proposed before. They can be used to prevent a door from closing. However, for these door holders, users generally need to push somewhere, remove the door holder, or pull the door hardly to close the door. A doorstop is used to prevent a door from open further to protect the door handle and wall. Most door holders and door stops are separate and function independently.

The door holders need to be made user-friendly. That means that users can close the door without any extra actions. The structure of the door holder needs to be made simpler so that the holders can be easily manufactured at a low cost.

### SUMMARY OF THE INVENTION

The purpose of the present invention is to make a simpler, user friendly, and more efficient door holder and stop that work together to hold the door from moving further and back while the door is opened.

The fractional door holder and stop is designed to properly characterize the working functions of the product as well as define the physical appearance. Typical use of the product, its basic design, and production materials are considered.

It is designed to provide users with a fractional door holder and stop that holds a door as shown in the design drawing. It simply consists of a frictional door holder, a door stop, and a buffer. The door holder is basically made of sheet metals, the door stop metals or plastics, and the buffer rubbers.

When the door is opened and contacts the buffer, it is stopped by the door stop and the buffer, and the door holder holds the door. As a result, the door is prevented from moving further and back. The door can be very easily closed as usual, and a user doesn't need any extra actions such as releasing the door holder by a hand or a foot. It can be used for the doors with a little returning moment such as the doors without a door closer.

The unique characteristics for the present invention are user-friendly and simple. The door can be stopped, held and closed without any extra effort. Its structure is very simple; therefore is can be easily manufactured at a low cost. Also combining the door holder and door stop together would benefit the users and manufactures.

Colors and other aesthetic considerations for the frictional door holder and stop can be as various as the custom desire, but should probably reflect the current trends in the related industry.

Due to the door holder and stop's very simple components, it should be no problem to produce from any technical standpoint. Existing manufacturing lines could easily be adapted for its speedy manufacture.

### BRIEF DESCRIPTION OF THE DRAWINGS

FIG. 1 is a perspective view of the frictional door holder and stop

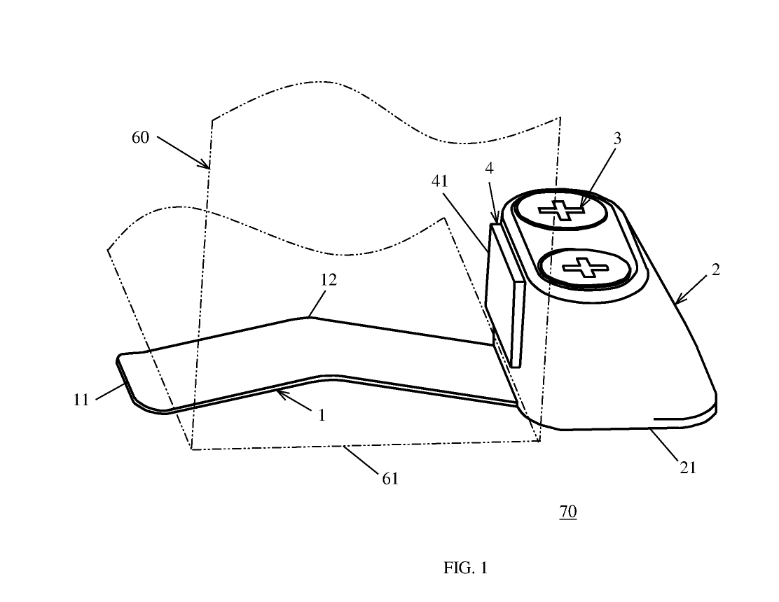

FIG. 2 is a front view of the frictional door holder and stop

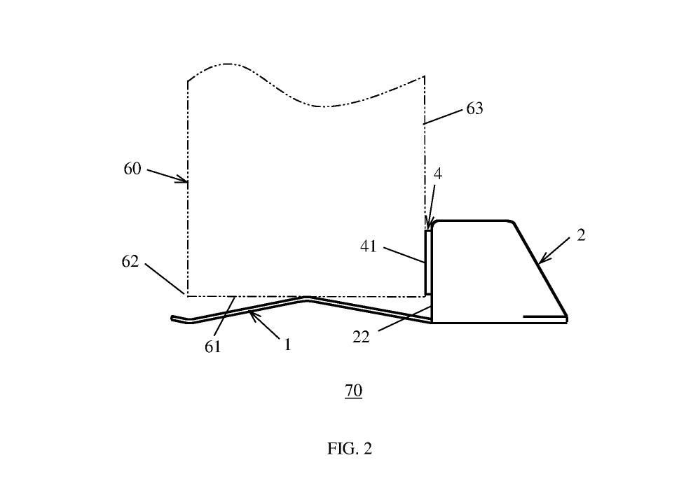

FIG. 3 is a top view of the frictional door holder and stop

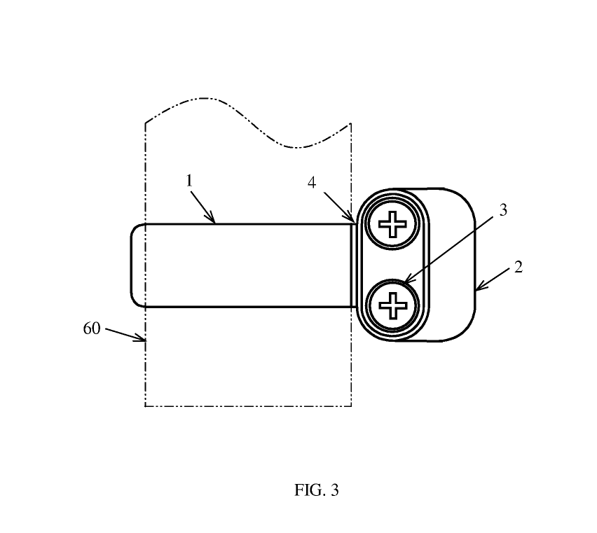

FIG. 4 is a bottom view of the frictional door holder and stop

FIG. 5 is a front view of the frictional door holder and stop with a stop base

### DESCRIPTION OF THE PREFERRED EMBODIMENT

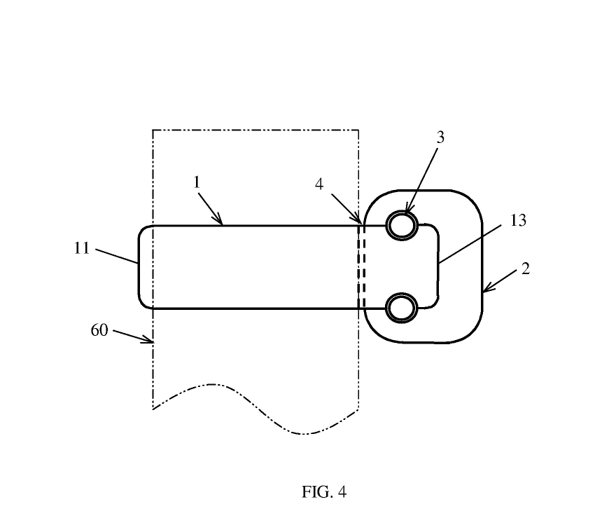

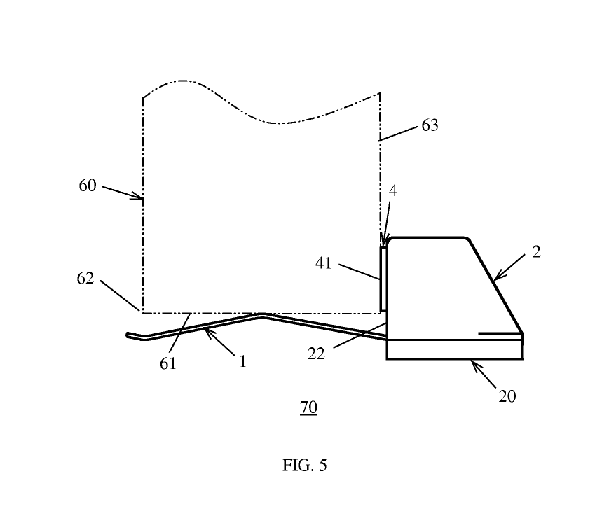

Turning now to the drawings, in which similar reference characters denote similar elements throughout the several views, it is seen that the frictional door holder and stop is comprised of a frictional door holder 1, a door stop 2, and a buffer 4. The door holder 1 has a bent shape with a top 12 near its middle. Its rear end 13 is set underneath the door stop 2 to be held to a fixed position relative to the door stop 2 and a floor 70 by screws 3 (FIG. 4). The front end 11 of the door holder 1 is bent upward to reduce the friction force between the door holder and the floor and prevent the floor from being scratched. The door stop 2 has two vertical holes to receive the two screws 3 with the bottom surface 21 having the same level as the bottom surface of the door holder 1. The buffer 4 is adhered and/or inlaid to door stop 2. In the case of the larger vertical elevation between the door's bottom surface 61 and the floor 70 such as the spacing for the floor with a thick carpet, a door stop base 20 is used to elevate other components of this device as shown in FIG. 5.

The door holder 1 is basically made of sheet metals since certain elasticity is needed; the door stop 2 is made of metals or plastics; and the buffer 4 is made of rubbers to absorb impact from the door.

The door holder can be easily adjusted by user hands for each door so that the door holder top 12 is a little higher than the door bottom surface 61 while the door holder front end 11 is lower than the door bottom surface 61. In the process of opening the door, the edge 62 of the door bottom surface 61 first passes through the door holder front end 11, and then pushes the door holder top 12 downward. After that, the door bottom surface 61 slides over the door holder top 12 while the door is opened further until the door rear face 63 contacts the buffer 4. The deformed door holder will hold the door there and prevent the door from swinging back. The door can be easily closed as usual, and a user doesn't need any extra actions such as releasing the holder by a hand or a foot.

The present invention is used with conventional mounted doors with little returning force that make the doors back such as the doors without a door closer. Experimental results show that the aforementioned door holder can provide enough frictional force to hold this kind of doors.

It is to be understood that the present invention is not limited to the above-mentioned embodiments, but encompasses any and all embodiments within the following scope of the claims.

What is claimed is:

1. A floor mounted frictional door holder and stop comprising:
a door stop positioned to prevent a door from swinging past a predetermined position, said door stop being fixed to a floor;
a door holder, a bent sheet metal structure, having a door holder top near the middle to contact the bottom surface of a conventional mounted door with a little retuning force making the door back, a door holder front end, and a door holder rear end set underneath said door stop to be held to a fixed position relative to said door stop and floor by connectors; and
wherein said door holder can be easily adjusted by user hands for each door so that said door holder top is a little higher than the door bottom surface while said door holder front end is lower than the door bottom surface, in the process of opening the door, the edge of the door bottom surface first passes through said door holder front end, and then pushes said door holder top downward, the door bottom surface slides over said door holder top while the door is opened further until the door is stopped, the deformed door holder will hold the door there and prevent the door from swinging back, and the door can be easily closed as usual without any extra actions such as releasing a holder by a hand or a foot.

2. The frictional door holder and stop of claim 1, wherein a buffer is adhered and/or inlaid to said door stop.

3. The frictional door holder and stop of claim 1, wherein the bottom surface of said door holder rear end set underneath said door stop is on a level with the bottom surface of said door stop.

4. The frictional door holder and stop of claim 1, wherein said door holder front end is bent upward to reduce the friction force between said door holder and the floor and prevent the floor from being scratched.

5. The frictional door holder and stop of claim 1, wherein a door stop base is used to elevate other components of this device in the case of the larger vertical elevation of the door's bottom over the underlying floor such as the spacing for the floor with a thick carpet.
